(19) United States
(12) Patent Application Publication
(10) Pub. No.: US 2023/0052475 A1
(43) Pub. Date: Feb. 16, 2023

(54) PATENT TRANSACTION PREDICTION METHOD AND SYSTEM, AND PATENT TRANSACTION PLATFORM

(71) Applicant: CHINA SOUTHERN POWER GRID RESEARCH INSTITUTE CO., LTD, Guangzhou, Guangdong (CN)

(72) Inventors: Guangkai LI, Guangzhou (CN); Jin ZHENG, Guangzhou (CN); Sen ZENG, Guangzhou (CN); Liyong DUAN, Guangzhou (CN); Yongjun LIU, Guangzhou (CN); Yujing GONG, Guangzhou (CN); Chunjie ZHEN, Baoding (CN)

(73) Assignee: CHINA SOUTHERN POWER GRID RESEARCH INSTITUTE CO., LTD, Guangzhou, Guangdong (CN)

(21) Appl. No.: 17/789,688

(22) PCT Filed: Aug. 11, 2020
(86) PCT No.: PCT/CN2020/108472

§ 371 Date: Jun. 28, 2022

(30) Foreign Application Priority Data
Dec. 28, 2019 (CN) 201911384503.2

(51) Int. Cl. G06Q 50/18

(52) U.S. Cl. CPC G06Q 50/184

(57) ABSTRACT

Provided is a patent transaction prediction method, comprising the following steps: obtaining to-be-predicted patent data(S1); constructing a prediction model, which is executed by a computer to predict a transaction probability of to-be-predicted patent data(S2); and displaying the transaction probability in a data attribute of the to-be-predicted patent data(S3). According to the method, the probability of patent transactions is displayed in the attribute of the patent data, improving the probability of patent transaction. Also provided are a patent transaction prediction system and a patent transaction platform, which also have the above-mentioned advantages.

### TECHNICAL FIELD

The present disclosure relates to the technical field of communications, and in particular to a patent transaction prediction method and system, and a patent transaction platform.

### BACKGROUND

At present, the transaction volume in China's technology market is growing rapidly, and technology services such as technology transactions based on the Internet have great potential. The online transaction service technology is developed in order to reduce transaction costs, solve the problem of information asymmetry in the transaction process, and improve the ability of service collaboration and sharing.

In the process of patent transaction, if the platform manager cannot predict the trend and potential of patent transaction, the online patent transaction may operate inefficiently.

### SUMMARY

An objective of the present disclosure is to provide a patent transaction prediction method and system, and a patent transaction platform, which solve the technical problem of patent transaction trend prediction.

In order to achieve the above Objective, the present disclosure provides a patent transaction prediction method, which includes the following steps: acquiring data of a target patent; constructing a prediction model, and executing the prediction model by a computer to predict a transaction probability of the target patent; and displaying the transaction probability in an attribute of the target patent.

Preferably, the constructing a prediction model may include: acquiring a collection of transacted patents; acquiring initial predictors for the collection of transacted patents; constructing, based on the initial predictors, an initial prediction model for the transaction probability; selecting, based on correlations between the initial predictors and the initial prediction model, a predictor from the initial predictors, and determining a weight; and constructing the prediction model based on the predictor and the weight.

Preferably, the constructing, based on the initial predictors, an initial prediction model for the transaction probability may include: constructing the initial prediction model based on at least multiple initial predictors selected from the following parameters: family size, number of forward citations, number of claims, number of international patent classifications (IPCs), number of inventors, number of backward citations, maintenance time, type of patent owner, straight-line distance between patent owner and patent transaction platform, and transaction price.

Preferably, the selecting, based on correlations between the initial predictors and the initial prediction model, a predictor from the initial predictors, and determining a weight may include: determining the predictor based on a value for rejecting a null hypothesis for the initial predictors and the transaction probability.

Preferably, the initial prediction model may be a logistic regression model.

Preferably, in the logistic regression model, the transaction probability of the patent may be P(yᵢ=|x₁, x₂, . . . , xᵢ), which may satisfy:

$$ln \frac{P}{1 - P} = {β}_{0} + {β}_{1} {x}_{1} + {β}_{2} {x}_{2} + … + {β}_{i} {x}_{i} = Z$$

$$P ( {y}_{i} = 1 \vert {x}_{1} , {x}_{2} , … , {x}_{i} ) = \frac{1}{1 + exp ( - Z )} = \frac{{e}^{{β}_{0} + {β}_{1} {x}_{1} + {β}_{2} {x}_{2} + … + {β}_{i} {x}_{i}}}{1 + {e}^{{β}_{0} + {β}_{1} {x}_{1} + {β}_{2} {x}_{2} + … + {β}_{i} {x}_{i}}}$$

where, β₀ denotes a constant term, and β₁ to βᵢ denote coefficients of independent variables x₁ to xᵢ, respectively.

The patent transaction prediction method of the present disclosure constructs an initial prediction model based on initial predictors, selects a predictor based on correlations between the initial predictors and the initial prediction model, constructs a prediction model, and acquires a transaction probability of a target patent. Compared with the prior art, the patent transaction prediction method of the present disclosure realizes prediction of the patent transaction probability, and promotes the operation efficiency of the patent transaction platform in patent transaction.

The present disclosure further provides a patent transaction prediction system, including: a receiving unit, configured to acquire data of a target patent; and a processing unit, configured to construct a prediction model, execute the prediction model by a computer to predict a transaction probability of the target patent, and display the transaction probability in an attribute of the target patent.

Preferably, the processing unit may be specifically configured to: acquire a collection of transacted patents; acquire initial predictors for the collection of transacted patents; construct, based on the initial predictors, an initial prediction model for the transaction probability; select, based on correlations between the initial predictors and the initial prediction model, a predictor from the initial predictors, and determine a weight; and construct the prediction model based on the predictor and the weight.

Preferably, the processing unit may be further configured to: construct the initial prediction model based on at least multiple initial predictors selected from the following parameters: family size, number of forward citations, number of claims, number of IPCs, number of inventors, number of backward citations, maintenance time, type of patent owner, straight-line distance between patent owner and patent transaction platform, and transaction price; and determine the predictor based on a value for rejecting a null hypothesis for the initial predictors and the transaction probability.

Compared with the prior art, the patent transaction prediction system of the present disclosure has the same beneficial effects as the patent transaction prediction method, which will not be repeated herein.

The present disclosure further provides a patent transaction platform, including the patent transaction prediction system.

Compared with the prior art, the patent transaction platform of the present disclosure has the same beneficial effects as the patent transaction prediction method, which will not be repeated herein.

### BRIEF DESCRIPTION OF THE DRAWINGS

FIG. 1 is a flowchart of a patent transaction prediction method according to the present disclosure:

FIG. 2 is a flowchart of constructing a prediction model according to the present disclosure;

and

FIG. 3 is a structural block diagram of a patent transaction prediction system according to the present disclosure.

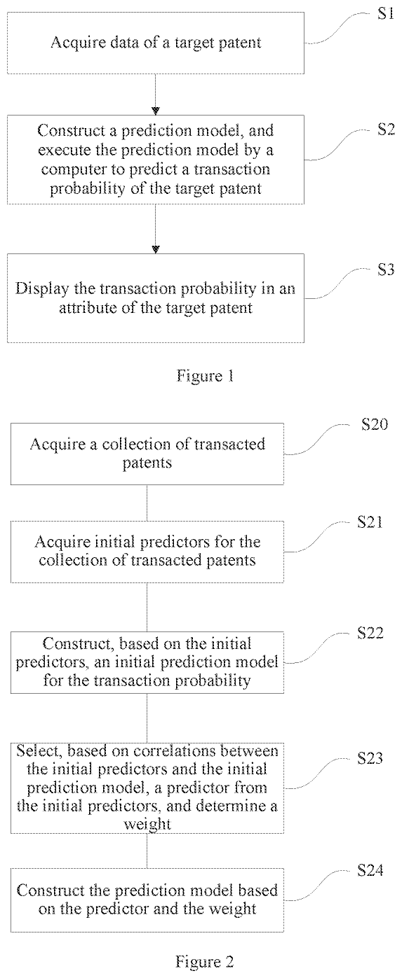

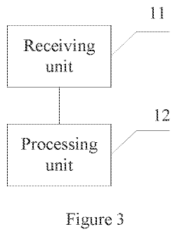

### REFERENCE NUMERALS

11. receiving unit; and 12, processing unit.

### DETAILED DESCRIPTION OF THE EMBODIMENTS

The technical solutions in the embodiments of the present disclosure are described dearly and completely below with reference to the drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts should fall within the protection scope of the present disclosure.

In the embodiments of the present disclosure, “multiple” means two or more. The term “and/or” describes associations between associated objects, and it indicates three types of relationships. For example, “A and/or B” may indicate A alone, A and B, or B alone. The terms such as “exemplary” or “such as” are intended to denote an example, illustration, or description so as to present the relevant concept in a particular manner, and should not be construed as preferred or advantageous over other embodiments or designs.

First, a related term involved in the embodiments of the present disclosure is defined as follows:

International patent classification (IPC) provides for a hierarchical system of language independent symbols for the classification of patents and utility models according to the different areas of technology to which they pertain.

With the development of society, patent transaction platforms and management systems for trading patents as commodities are increasingly emerging. However, due to the lack of prediction of patent transactions, a large number of patents are left idle.

In order to solve the above technical problem, the present disclosure provides a patent transaction prediction method and system, and a patent transaction platform.

As shown in FIG. 1, the present disclosure provides a patent transaction prediction method including following steps:

S1. Acquire data of a target patent.

It should be noted that the patent transaction prediction method of the present disclosure is applied to a patent transaction platform. There are numerous patents on the patent transaction platform, form which initial predictors of patents can be acquired. The initial predictors include: family size, number of forward citations, number of claims, number of international patent classifications (IPCs), number of inventors, number of backward citations, maintenance time, type of patent owner, straight-line distance between patent owner and patent transaction platform, and transaction price. It should be understood that the constructing of different patent prediction models may not be limited to these predictors.

S2. Construct a prediction model, and execute the prediction model by a computer to predict a transaction probability of the target patent.

In this embodiment, an initial prediction model is first built based on the initial predictors, and then the prediction model is built by analyzing the initial predictors and selecting a predictor. A target patent is selected, and then the transaction probability of the patent is predicted.

A patent transaction involves changes in the legal status of the patent, including authorized, licensed, assigned, pledged, and invalid. It should be understood that the patent transaction is not limited to changes in the legal status of the patent.

S3. Display the transaction probability in an attribute of the target patent.

The value of the transaction probability is displayed in the attribute of the target patent for users to browse on the patent transaction platform, thereby improving the transaction possibility of the target patent.

With the above technical solution, the transaction probability of the target patent is predicted by the prediction model and displayed in the attribute of the patent, thereby improving the transaction probability of the target patent.

Based on the above embodiment, further, the constructing a prediction model includes:

S20. Acquire a collection of transacted patents.

S21. Acquire initial predictors for the collection of transacted patents.

S22, Construct, based on the initial predictors, an initial prediction model for the transaction probability.

S23. Select, based on correlations between the initial predictors and the initial prediction model, a predictor from the initial predictors, and determine a weight.

S24. Construct the prediction model based on the predictor and the weight.

Based on the above embodiment, further, the constructing, based on the initial predictors, an initial prediction model for the transaction probability includes: construct the initial prediction model based on at least multiple initial predictors selected from the following parameters: family size, number of forward citations, number of claims, number of international patent classifications (IPCs), number of inventors, number of backward citations, maintenance time, type of patent owner, straight-line distance between patent owner and patent transaction platform, and transaction price.

It should be noted that the transaction price shows the patent owner's expectation of the patent value. The straight-line distance between the patent owner and the patent transaction platform will influence the identification and supervision costs of the patent transaction platform. The maintenance time represents an actual time from the filing date to the date of invalidation, termination, revocation or expiry of the patent. The type of patent owner includes individual, enterprise, university, and scientific research institution. The number of forward citations is the number of times the patent is cited by a later patent. The number of IPCs is the number of international patent classifications for the patent. The number of backward citations refers to the number of previous patent documents cited in the application document of the patent. The family size refers to the number of patents with common priority applied for and published by the patent owner in different countries or regions.

Based on the above embodiment, further, the selecting, based on correlations between the initial predictors and the initial prediction model, a predictor from the initial predictors, and determining a weight includes: determine the predictor based on a value for rejecting a null hypothesis for the initial predictors and the transaction probability.

It should be noted that if the value for rejecting the null hypothesis for the initial predictor and the transaction probability is less than 0.05, the initial predictor is selected as the predictor.

Based on the above embodiment, further, the initial prediction model is a logistic regression model.

In this embodiment, the logistic regression model is a binary logistic regression model.

Based on the above embodiment, further; in the logistic regression model, the transaction probability of the patent is P(yᵢ=|x₁, x₂, . . . , xᵢ), which satisfies:

$$ln \frac{P}{1 - P} = {β}_{0} + {β}_{1} {x}_{1} + {β}_{2} {x}_{2} + … + {β}_{i} {x}_{i} = Z$$

$$P ( {y}_{i} = 1 \vert {x}_{1} , {x}_{2} , … , {x}_{i} ) = \frac{1}{1 + exp ( - Z )} = \frac{{e}^{{β}_{0} + {β}_{1} {x}_{1} + {β}_{2} {x}_{2} + … + {β}_{i} {x}_{i}}}{1 + {e}^{{β}_{0} + {β}_{1} {x}_{1} + {β}_{2} {x}_{2} + … + {β}_{i} {x}_{i}}}$$

where, β₀ denotes a constant term, and β₁ to βᵢ denote coefficients of independent variables x₁ to xᵢ, respectively.

The present disclosure further provides a patent transaction prediction system, including: a receiving unit 11, configured to acquire data of a target patent; and a processing unit 12, configured to construct a prediction model, execute the prediction model by a computer to predict a transaction probability of the target patent, and display the transaction probability in an attribute of the target patent.

Based on the above embodiment, further, the processing unit 12 is specifically configured to: acquire a collection of transacted patents; acquire initial predictors for the collection of transacted patents; construct, based on the initial predictors, an initial prediction model for the transaction probability; select, based on correlations between the initial predictors and the initial prediction model, a predictor from the initial predictors, and determine a weight; and construct the prediction model based on the predictor and the weight.

Based on the above embodiment, further, the processing unit 12 is further configured to: construct the initial prediction model based on at least multiple initial predictors selected from the following parameters: family size, number of forward citations, number of claims, number of number of inventors, number of backward citations, maintenance time, type of patent owner, straight-line distance between patent owner and patent transaction platform, and transaction price; and determine the predictor based on a value for rejecting a null hypothesis for the initial predictors and the transaction probability.

The present disclosure further provides a patent transaction platform, including the patent transaction prediction system.

The present disclosure further provides a specific embodiment of the patent transaction prediction method, as follows:

Among the listed patents on an online technology transaction platform, those in the IPC class A61 were selected as the analysis targets. There were a total of 87 patents in the IPC class A61, including 15 valid patents, 42 assigned patents, and 30 invalid patents.

The transaction probability of the patents was analyzed in terms of changes in the legal status of the patents, namely assigned, and invalidated due to failure of the patent owner to pay the annual fee. That is, based on the two influencing factors of changes in the legal status, a relevant prediction model was built.

In order to construct the prediction model based on these two changes in the legal status, two main predictors for online patent transactions were determined, namely A: change in the legal status of the patent incurred by assignment, and B: change in the legal status of the patent incurred by invalidation due to failure of the patent owner to pay the annual fee. The changes in the legal status were taken as dependent variables of the statistical analysis.

The following initial predictors were selected: family size, number of forward citations, number of claims, number of IPCs, number of inventors, number of backward citations, maintenance time, straight-line distance between patent owner and patent transaction platform, and transaction price.

The dependent variables were binary variables, so the regression analysis was performed by a using binary logistic model. In the regression model, when the dependent variable y was 1, it indicated a change in the legal status, that is, A or B. When the dependent variable y was 0, it indicated no change in the legal status. A function P was built to express the probability of the change in the legal status, that is, A or B. The independent variables in the function P were denoted as x₁, x₂, . . . , xᵢ, respectively. In this way, the logistic regression model for estimating the probability of the change in the legal status was built.

The probability P(yᵢ=|x₁, x₂, . . . , xₜ), which may satisfy: for the change in the legal status of the patent was expressed as:

$$ln \frac{P}{1 - P} = {β}_{0} + {β}_{1} {x}_{1} + {β}_{2} {x}_{2} + … + {β}_{i} {x}_{i} = Z$$

$$P ( {y}_{i} = 1 \vert {x}_{1} , {x}_{2} , … , {x}_{i} ) = \frac{1}{1 + exp ( - Z )} = \frac{{e}^{{β}_{0} + {β}_{1} {x}_{1} + {β}_{2} {x}_{2} + … + {β}_{i} {x}_{i}}}{1 + {e}^{{β}_{0} + {β}_{1} {x}_{1} + {β}_{2} {x}_{2} + … + {β}_{i} {x}_{i}}}$$

where, β₀ denoted a constant term, and βᵢ to βᵢ denoted regression coefficients of independent variables x₁ to xᵢ, respectively.

For the regression analysis of the dependent variable A, a forward selection strategy was used to gradually introduce the independent variables into the regression equation until no more statistically significant independent variables were introduced. Finally, there were 6 independent variables introduced into the regression equation, that is, the number of forward citations, the number of claims, the number of IPCs, the number of backward citations, the listed price, and the distance between the patent owner and the Patent Trading Platform.

Based on the result of the dependent variable A derived by the regression model, the transfer probability P of a patent i was predicted as:

$$P ( {y}_{i} = 1 \vert {x}_{1} , {x}_{2} , {x}_{3} , {x}_{4} , {x}_{5} , {x}_{6} ) = \frac{{e}^{- 0.502 * number of forward citations + 0.45 * number of claims + 0.395 * number of IPCs + 1. 465 * number of backward citations - 0.969 * listed price - 1.329 * distance between patent owner and online technology transaction platform - 2.258}}{1 + {e}^{- 0.502 * number of forward citations + 0.45 * number of claims + 0.395 * number of IPCs + 1. 465 * number of backward citations - 0.969 * listed price - 1.329 * distance between patent owner and online technology transaction platform - 2.258}}$$

Similarly, for the regression analysis of the dependent variable B, there were 5 independent variables finally introduced into the regression equation, that is, the number of forward citations, the number of claims, the number of backward citations, the number of inventors, and the maintenance time.

Based on the result of the dependent variable B derived by the regression model, the probability P for invalidation of the patent i due to failure of the patent owner to pay the annual fee was predicted as:

$$P ( {y}_{i} = 1 \vert {x}_{1} , {x}_{2} , {x}_{3} , {x}_{4} , {x}_{5} ) = \frac{{e}^{0.446 * number of forward citations - 0.32 * number of claims - 0.991 * number of backward citations + 0.629 * number of inventors - 0.39 * maintenance time + 1.147}}{1 + {e}^{0.446 * number of forward citations - 0.32 * number of claims - 0.991 * number of backward citations + 0.629 * number of inventors - 0.39 * maintenance time + 1.147}}$$

The above-mentioned embodiments are merely intended to describe the preferred implementations of the present disclosure, rather than to limit the concept and scope of the present disclosure. Various modifications and improvements made by those of ordinary skill in the art to the technical solutions of the present disclosure without departing from the design concept of the present disclosure should fall within the protection scope of the present disclosure. The technical content claimed by the present disclosure is fully recorded in the claims.

1. A patent transaction prediction method, applied to a patent transaction platform, and comprising the following steps:
acquiring data of a target patent;
constructing a prediction model, and executing the prediction model by a computer to predict a transaction probability of the target patent; and
displaying the transaction probability in an attribute of the target patent.

2. The patent transaction prediction method according to claim 1, wherein the constructing a prediction model comprises:
acquiring a collection of transacted patents;
acquiring initial predictors for the collection of transacted patents;
constructing, based on the initial predictors, an initial prediction model for the transaction probability;
selecting, based on correlations between the initial predictors and the initial prediction model, a predictor from the initial predictors, and determining a weight; and
constructing the prediction model based on the predictor and the weight.

3. The patent transaction prediction method according to claim 2, wherein the constructing, based on the initial predictors, an initial prediction model for the transaction probability comprises:
constructing the initial prediction model based on at least multiple initial predictors selected from the following parameters: family size, number of forward citations, number of claims, number of international patent classifications (IPCs), number of inventors, number of backward citations, maintenance time, type of patent owner, straight-line distance between patent owner and patent transaction platform, and transaction price.

4. The patent transaction prediction method according to claim 1, wherein the selecting, based on correlations between the initial predictors and the initial prediction model, a predictor from the initial predictors, and determining a weight comprises: determining the predictor based on a value for rejecting a null hypothesis for the initial predictors and the transaction probability.

5. The patent transaction prediction method according to claim 4, wherein the initial prediction model is a logistic regression model.

6. The patent transaction prediction method according to claim 5, wherein in the logistic regression model, the transaction probability of the patent is P(yᵢ=|x₁, x₂, . . . , xᵢ), which satisfies:
$$ln \frac{P}{1 - P} = {β}_{0} + {β}_{1} {x}_{1} + {β}_{2} {x}_{2} + … + {β}_{i} {x}_{i} = Z$$
$$P ( {y}_{i} = 1 \vert {x}_{1} , {x}_{2} , … , {x}_{i} ) = \frac{1}{1 + exp ( - Z )} = \frac{{e}^{{β}_{0} + {β}_{1} {x}_{1} + {β}_{2} {x}_{2} + … + {β}_{i} {x}_{i}}}{1 + {e}^{{β}_{0} + {β}_{1} {x}_{1} + {β}_{2} {x}_{2} + … + {β}_{i} {x}_{i}}}$$
wherein, β₀ denotes a constant term, and β₁ to βᵢ denote coefficients of independent variables xᵢ to xᵢ, respectively.

7. A patent transaction prediction system for applying to a patent transaction platform, comprising:
a receiving unit, configured to acquire data of a target patent; and
a processing unit, configured to construct a prediction model, execute the prediction model by a computer to predict a transaction probability of the target patent, and display the transaction probability in an attribute of the target patent.

8. The patent transaction prediction system according to claim 7, wherein the processing unit is specifically configured to:
acquire a collection of transacted patents;
acquire initial predictors for the collection of transacted patents;
construct, based on the initial predictors, an initial prediction model for the transaction probability;
select, based on correlations between the initial predictors and the initial prediction model, a predictor from the initial predictors, and determine a weight; and
construct the prediction model based on the predictor and the weight.

9. The patent transaction prediction system according to claim 8, wherein the processing unit is further configured to:
construct the initial prediction model based on at least multiple initial predictors selected from the following parameters: family size, number of forward citations, number of claims, number of IPC s, number of inventors, number of backward citations, maintenance time, type of patent owner, straight-line distance between patent owner and patent transaction platform, and transaction price; and
determine the predictor based on a value for rejecting a null hypothesis for the initial predictors and the transaction probability.

10. A patent transaction platform, comprising a patent transaction prediction system, and the patent transaction prediction system comprising:
a receiving unit, configured to acquire a target patent; and
a processing unit, configured to construct a prediction model, execute the prediction model by a computer to predict a transaction probability of the target patent, and display the transaction probability in an attribute of the target patent.
